(19) United States
(12) Patent Application Publication
(10) Pub. No.: US 2025/0388830 A1
(43) Pub. Date: Dec. 25, 2025

(54) A Method of Manufacturing a Scented Candle

(71) Applicant: Reckitt & Colman (Overseas) Hygiene Home Limited, Slough, Berkshire (GB)

(72) Inventors: Isabelle BOSSARD, Hull (GB); Marina MIXTRO SERRASQUEIRO, Hull (GB); Lewis PEACOCK, Hull (GB); Saad QUMMER, Hull (GB); Damian TARASEK, Hull (GB); Umberto TONIOLO, Heidelberg (DE); Wenhao ZHANG, Dongguan, Guangdong (CN)

(21) Appl. No.: 19/107,665

(22) PCT Filed: Sep. 1, 2023
(86) PCT No.: PCT/GB2023/052267

§ 371 Date: Feb. 28, 2025

(30) Foreign Application Priority Data
Sep. 2, 2022 (WO) PCT/CN2022/116754

(51) Int. Cl. C11C 5/00

(52) U.S. Cl. CPC C11C 5/002

(57) ABSTRACT

A method of manufacturing a scented candle is disclosed, wherein the candle comprises a wax or gel body, at least one wick and a fragrance or fragrance composition included in the wax or gel body. The method comprises: Providing a wax or a gel for forming the wax or gel body, providing a fragrance or a fragrance composition to be added to the wax or gel, providing at least one wick to be integrated into the wax or gel body, wherein the wick partially protrudes from the wax or gel body such that it can be lighted, and combining the wax or gel with the fragrance or fragrance composition and the at least one wick, to form the scented candle. Said providing of the fragrance or fragrance composition includes deliberately selecting the fragrance respectively fragrance composition based on its flashpoint and/or alcohol content, wherein the flashpoint is at least 82.5° C. If the alcohol content is higher than 18 wt. %, a lactones content of the fragrance respectively fragrance composition preferably is at most 1.7 wt %.

The present disclosure relates to a method of manufacturing a scented candle.

Candles are very popular with consumers, specifically in the home. In particular, scented candles—which include one or more fragrance oils mixed into the wax—are a nice touch in a bedroom, a living room or a bathroom by releasing a pleasant aroma. A scented candle can create an ambiance of healthfulness and wellbeing.

Unlike incense burners, scented candles do not add smoke to the air.

However, scented candles have been found to emit potentially harmful chemicals such as formaldehyde, benzene and/or naphthalene.

It is an object of the present invention to provide a method for manufacturing a scented candle having a low emission profile, in particular with regard to minimising levels of formaldehyde, benzene and/or naphthalene which occur during the burning process.

This objective is achieved by a method of manufacturing a scented candle, the candle comprising a wax or gel body, at least one wick and a fragrance or fragrance composition included in the wax or gel body, wherein the method comprises:
a) Providing a wax or a gel for forming the wax or gel body,
b) Providing a fragrance or a fragrance composition to be added to the wax or gel,
c) Providing at least one wick to be integrated into the wax or gel body, wherein the wick partially protrudes from the wax or gel body such that it can be lighted, and
d) Combining the wax or gel with the fragrance or fragrance composition and the at least one wick, to form the scented candle.

In such method, the providing of the fragrance or fragrance composition in step b) includes deliberately selecting the fragrance respectively fragrance composition based on its flashpoint, wherein the flashpoint is at least 82.5° C., and/or its alcohol content.

The flashpoint refers to the temperature at which a fragrance can combust or ignite if exposed to an open flame or spark. It is a commonly stated property when a fragrance or fragrance composition is marketed.

When analysing about 160 data points related to existing scented candles (of various wax compositions, and including various fragrances or fragrance compositions) and the respective fragrance flashpoint associated with the fragrance or fragrance composition used in said candles, the inventors have found out that the emission levels of e.g., formaldehyde and benzene correlate with the fragrance flashpoint: The higher the fragrance flashpoint, the lower the respective emissions. From an analysis of said data points, they found out that when a fragrance or fragrance composition with a fragrance flashpoint of more than 82.5° C. is used with the scented candle, the chance of successfully passing an emission objective of maximum e.g., 30 micrograms/(unit m³) for formaldehyde as well as maximum e.g. 0.17 micrograms/m³ per day for benzene is about 99%.

It has been found as well when analysing the about 160 data points, that the alcohol content of the fragrance or fragrance composition is also correlated with the candle passing the emission test: If the alcohol content is at most 18 wt. %, the probability of passing the emission test is about 84% or higher. If the alcohol content is higher than 18 wt. %, and the fragrance or fragrance composition has a lactones content of at most 1.7 wt. %, the candle also has a high chance of passing the emission test of 70% or higher.

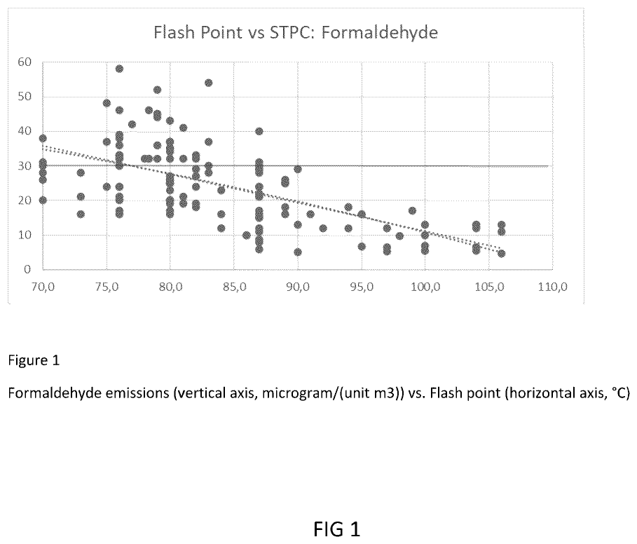

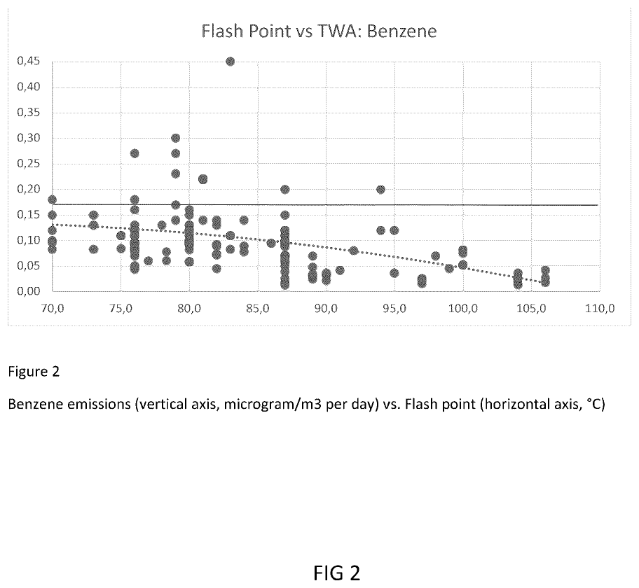

FIGS. 1 and 2 show measurements related to emissions of formaldehyde and benzene with respect to the mentioned 160 samples:

FIG. 1 exhibits the formaldehyde emissions, and

FIG. 2 shows the benzene emissions.

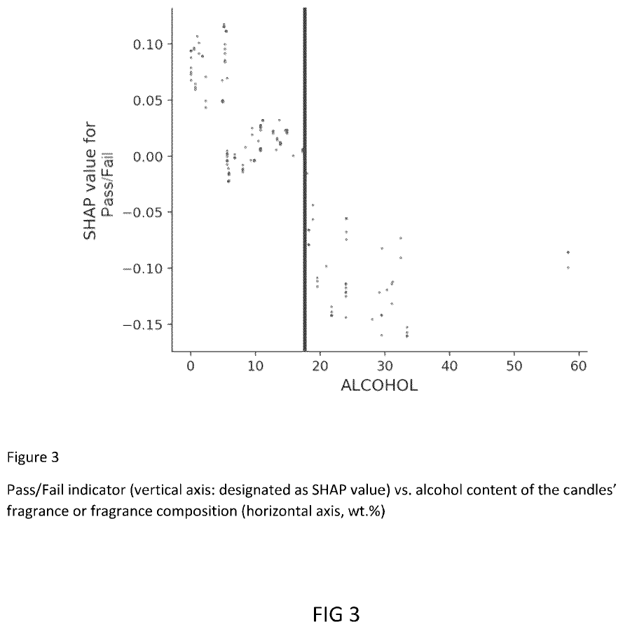

FIG. 3 shows the correlation between alcohol content of the fragrance or fragrance composition and a candle's chances to pass the emission test.

FIG. 1 shows small full circles each representing a tested candle, exhibiting the respective formaldehyde emissions (vertical axis) and the related fragrance flashpoint (horizontal axis). It can be seen that a fragrance flashpoint of >82.5° C. will lead to the vast majority of the candles emitting formaldehyde at a level lower than the targeted e.g., 30 micrograms/(unit m³). “STPC” stands for “Single Time Point Concentration” and relates to norm EN16739. The latter has been chosen by the inventors as it appears to be the most stringent one regarding acceptable or maximum levels of formaldehyde, setting a maximum of 30 micrograms/(unit m³). The measured concentration of formaldehyde is representative of the concentration of formaldehyde in the “European Reference Room” (“unit”) having a volume of 30 m³ and an air exchange rate of 0.5/h after one hour of burning.

FIG. 2 shows small full circles each representing a tested candle, exhibiting the respective benzene emissions (vertical axis) and the related fragrance flashpoint (horizontal axis). It can be seen that a fragrance flashpoint of >82.5° C. will lead to the vast majority of the candles emitting benzene at a level lower than the targeted e.g. 0.17 micrograms/m³ per day. “TWA” stands for “Time Weighted Average” and relates to the WHO guidelines regarding acceptable or maximum levels of benzene. The latter have been chosen by the inventors as they appear to be the most stringent ones regarding acceptable or maximum levels of benzene, setting a maximum of 0.17 micrograms/m³ per day for benzene. The “Time Weighted Average” is the expected average from having one candle (of the respective specimen) burning in the “European Reference Room” on the basis of the worst case exposures for scented candles; here: 4 hours burning time per 24 hours, and a frequency of use of 4 times per 7 days.

Without wanting to be limited by theory, the inventors believe that the shown correlation of fragrance flashpoint and emission levels of formaldehyde respectively benzene is linked to the kinetics of combustion, in that a more complete combustion is correlated with a higher fragrance flashpoint; e.g., less CH₂O (formaldehyde) and/or C₆H₆ (benzene) are formed which can be looked at as potentially hazardous (intermediate) combustion products.

In the context of the invention, the deliberate selection of the fragrance respectively fragrance composition based on its flashpoint shall encompass designing the fragrance or fragrance composition, or mixing fragrance oils to arrive at a mix, such that it meets the stated flashpoint value requirement.

In a preferred embodiment, such fragrance or fragrance composition is deliberately chosen which has a flashpoint of at least 87.5° C., more preferably of at least 95° C. In this embodiment, the chances of meeting the emission objectives by the scented candle are further increased. In particular, the chances of meeting said emission objectives are about 100% when the fragrance flashpoint is at least 95° C.

In a second embodiment, the invention also encompasses a scented candle manufactured according to any method as stated above.

In an embodiment, the fragrance or fragrance composition of the scented candle constitutes between 1 and 10 wt. %, preferably between 4 and 6 wt. % and most preferably between 2 and 4 wt. %, of the wax or gel body. Based on the findings of the inventors as stated before, it is possible to choose a broad range of fragrance loads without violating the emission objectives.

In particular, high fragrance loads are possible (such as 6 wt. % or above) which can e.g., further improve the consumer experience with such candle, without incurring hazardous emissions from the candle.

In another embodiment, the fragrance or fragrance composition is deliberately chosen based on its alcohol content.

It can be seen from FIG. 3 that from the sample of about 160 datapoints, about 84% of candles pass the emission test when the alcohol content of their fragrance or fragrance composition is at most 18 wt. %. In the figure, the data points corresponding to a SHAP value (horizontal axis) below 0.00 correspond to candles having failed the emission test.

In a further embodiment, the scented candle comprises more than one wick, preferably two, three or four. Increasing the number of wicks can lead to impressive aesthetics of the burning candle, supporting creativity of the candle manufacturer/designer as well as broadening consumer experience. An increased number of (ignited) wicks, on the other hand, will also increase the emissions of the candle. However, such a candle designed and manufactured according to the method of the invention will still yield low emissions and can pass maximum emission objectives, e.g., with regard to formaldehyde and benzene.

Preferably, the formaldehyde emissions of a scented candle manufactured according to the method of the invention are below 30 micrograms/(unit m³) and/or the benzene emissions of a scented candle manufactured according to the invention are below 0.17 micrograms/m³ per day.

The invention can be summarised as follows:

A method of manufacturing a scented candle, wherein the candle comprises a wax or gel body, at least one wick and a fragrance or fragrance composition included in the wax or gel body. The method comprises:
a) Providing a wax or a gel for forming the wax or gel body,
b) providing a fragrance or a fragrance composition to be added to the wax or gel,
c) providing at least one wick to be integrated into the wax or gel body, wherein the wick partially protrudes from the wax or gel body such that it can be lighted, and
d) combining the wax or gel with the fragrance or fragrance composition and the at least one wick, to form the scented candle.

Said providing of the fragrance or fragrance composition in step b) includes selecting the fragrance respectively fragrance composition based on its flashpoint, wherein the flashpoint is at least 82.5° C., and/or based on its alcohol content, which preferably is at most 18 wt. %.

If the alcohol content is higher than 18 wt. %, a lactones content of the fragrance respectively fragrance composition preferably is at most 1.7 wt %.

1. A method of manufacturing a scented candle, the candle comprising a wax or gel body, at least one wick and a fragrance or fragrance composition included in the wax or gel body, the method comprising:
a) providing a wax or a gel for forming the wax or gel body;
b) providing a fragrance or a fragrance composition to be added to the wax or gel, including selecting the fragrance of fragrance composition based on:
i) its flashpoint, wherein the flashpoint is at least 82.5° C.
and/or,
ii) it alcohol content;
c) providing at least one wick to be integrated into the wax or gel body, wherein the wick partially protrudes from the wax or gel body such that it can be lighted; and
d) combining the wax or gel with the fragrance or fragrance composition and the at least one wick, to form the scented candle.

2. The method according to claim 1, wherein the flashpoint is at least 87.5° C., preferably at least 95° C.

3. The method according to claim 1, wherein the alcohol content is at most 18 wt. %.

4. The method according to claim 1, wherein the alcohol content is higher than 18 wt. % and a lactones content of the fragrance respectively fragrance composition is at most 1.7 wt %.

5. A scented candle, manufactured according to the method of claim 1.

6. The scented candle according to claim 5, wherein the fragrance or fragrance composition constitutes between 1 and 10 wt. %, preferably between 4 and 6 wt. %, and most preferably between 2 and 4 wt. % of the wax or gel body.

7. The scented candle according to claim 6, wherein the scented candle comprises more than one wick, preferably two, three or four.

8. The scented candle according to claim 5, wherein emissions of formaldehyde from the scented candle are below 30 micrograms/(unit m³), said emissions determined according to EN16739.

9. The scented candle according to claim 5, wherein emissions of benzene from the scented candle are below 0.17 micrograms/m³ per day, said emissions determined according to WHO guideline on benzene emissions, scenario 1/1000000 lifetime risk.

10. The scented candle according to claim 8, wherein emissions of formaldehyde are below 30 micrograms/(unit m³) and emissions of benzene are below 0.17 micrograms/m³ per day.
